(19) United States
(12) Patent Application Publication
(10) Pub. No.: US 2008/0163579 A1
(43) Pub. Date: Jul. 10, 2008

(54) Point Holder For Holding Glass Panes In A Bending Free Manner

(76) Inventors: Ralf Kreyenborg, Bad Salzuflen (DE); Thomas Vogler, Bad Salzuflen (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/795,883

(22) PCT Filed: Jan. 16, 2006
(86) PCT No.: PCT/EP06/00310

§ 371 Date: Jul. 24, 2007

(30) Foreign Application Priority Data
Jan. 24, 2005 (DE) 10 2005 003 300.8

(51) Int. Cl. E06B 3/54

(52) U.S. Cl. 52/474

(57) ABSTRACT

A single-point holder for fixing a glass pane relative to a sub-construction or support is disclosed. The holder includes two clamping fittings for clamping the glass pane therebetween, one of the clamping fittings comprising a hollow sphere bearing shell; a setting member connectable to the one of the two clamping fittings; and a connecting component connectable to the sub-construction or support and having a longitudinal axis, the connecting component comprising a ball head which is received in the hollow sphere bearing shell. The hollow sphere bearing shell is divided into first and second semi-spherical bearing shells in a plane normal to the longitudinal axis of the connecting component. The first and second semi-spherical bearing shells and the ball head form a ball-and-socket joint. When connected to the one of the two clamping fittings, the setting member sets and fixes the first and second semi-spherical bearing shells relative to each other.

The invention relates to a single-point fixing for the bending-moment-free holding of glass panes having clamping fittings clamping the glass pane between them, a connecting component being supported at one clamping fitting in a ball-and-socket joint and being attachable to a sub-construction, which component has a ball head, which is supported in a hollow sphere bearing shell of the clamping fitting.

Glass panes clamped by means of single-point fixings are subject to multiple constraints through exterior forces, such as wind, temperature variations or loads on account of different coefficients of expansion of the plates in relation to the sub-construction. Therefore, not only a tension-free mounting is a prerequisite; but also, once mounting is completed, the prescribed loads, which ultimately may result in the deflection of the glass pane, must be absorbed by the glass plate without any damage. For this purpose, multiple possibilities have been suggested for clamping the glass pane in the single-point fixing itself, as well as for connecting the single-point fixing to a sub-construction.

The document DE 43 40 511 A1 discloses a building structure of this species as a facade or as a roof, wherein a single-point fixing consists of a plate holder fastened to the plate, at which holder a connecting component, connectable to a sub-construction, is supported in a ball-and-socket joint. The ball-and-socket joint consists of a ball joint, which is supported in a hollow sphere bearing shell and disposed at the connecting component. Nothing is disclosed about the conception of the hollow sphere bearing shell.

The document EP 0 733 148 B1 relates to a holding device for the bending-moment-free support of glass plates, the ball head of a mounting bolt forming a ball joint bearing together with a correspondingly shaped part of a seating disk of a clamping fitting. The mobility of the ball head in the ball joint bearing is adjustable by means of a fastening bushing, which can be brought into contact with the ball head. The ball joint bearing is sealed from exterior influences by a sealing gasket, which receives lubricant if necessary, and, on the one hand is abutting against the seating disk, and on the other hand, against the mounting bolt. It is furthermore suggested to implant the ball head of the mounting bolt with plasma, for example boron, molybdenum, nitrogen and/or carbon at a very low temperature, in order to achieve a long lasting high slip between the ball head and two parts of the ball joint bearing.

In a single-point fixing of the species mentioned in the beginning, it is the object of the invention to optimize the connection between the clamping fitting clamping the glass pane and the connecting component, which is attachable to a sub-construction. In this case, while using a ball head at the connecting component, a cold welding between the ball head and ball socket should be eliminated, which occurs if tolerances overlap unfavourably resulting in local pressure areas.

The invention solves the given problem with the teaching according to claim 1.

According to the invention, by dividing the hollow sphere bearing shell, a precise adjustment of the hollow sphere half shells with regard to the ball head can be achieved, i.e. the play between the mirror-symmetrically disposed half shells and the ball head can be precisely defined by means of the tightening torque to be applied to the setting member.

With a fitting accuracy during manufacturing, the two facing frontal faces of the half shells can be brought into abutment, that is to say a safety gluing of the thread of the setting member can be omitted. According to the invention, during mounting there will be a planned collision of the mirror-symmetrically formed half shells in the area of the plane of division, such that even with a pairing of unfavourable tolerances, a locally different functioning of the ball joint will not occur.

Further advantageous features of the invention are characterized by the dependent claims.

In an embodiment of the invention, the clamping fitting is formed in two pieces and consists of a seating disk abutting the glass pane and a setting member, which can be screwed into the seating disk by means of a thread and has a glass bolt, wherein the setting member, by means of tapered surfaces, can be adjusted at a corresponding tapered surface of a hollow sphere half shell. Forming the two tapered surfaces, corresponding to each other, of the hollow sphere half shell, on the one side, and of the setting member on other side, is chosen advantageously such that, through the wedging in conjunction with a pre-selectable tightening torque, such a locking of the adjustment of the ball bearing can be achieved that an additional securing of the thread of the setting member is redundant. In addition, the tapered surfaces, on account of their oblique shape, allow for sensitively adjusting the hollow sphere half shell in relation to the ball head.

It has proven to be advantageous to manufacture the ball head, on the one side, and the hollow sphere bearing shell on the other side, from different materials; preferably the ball head is made from alloy steel, and the hollow sphere bearing shell is made from a suitable bearing bronze.

In the following the invention is explained in detail based on one exemplary embodiment, in which:

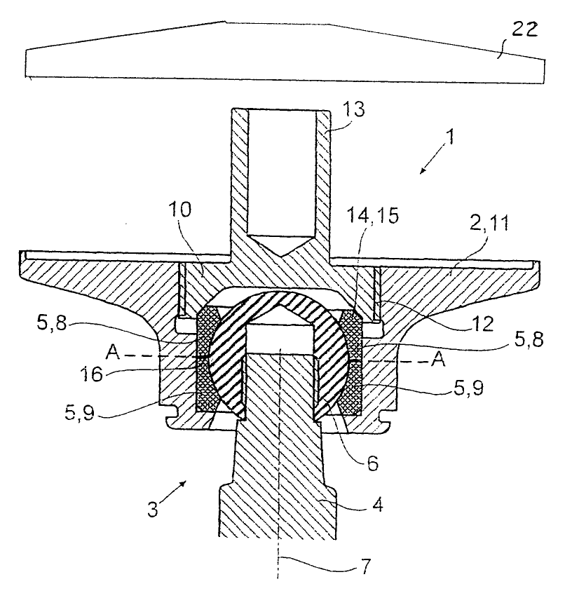

FIG. 1 shows a partial cross-section through a clamping fitting of a single-point fixing, whereby the complementary clamping fitting, intended for clamping the not illustrated glass pane, has been omitted for clarity's sake.

The single-point fixing 1 has a clamping fitting 2, abutting the not illustrated glass pane on the side facing the sub-construction, which fitting is connected to the not illustrated sub-construction via a connecting component 4 shown as a mounting bolt. The connecting component 4 is supported in the clamping fitting 2 in a tension-resistant and pressure-resistant manner by means of a ball-and-socket joint 3, i.e. by means of a universally rotatable joint. For this purpose, the connecting component 4 has a ball head 6, which is supported in a hollow sphere bearing shell 5. The ball head 6 is made of an alloy steel; the hollow sphere bearing shell 5 is made of a suitable bearing bronze. Orthogonally to the longitudinal axis 7 of the connecting component 4, i.e. parallel to the plane of the not illustrated glass pane in the area of the plane of division 16, the hollow sphere bearing shell 5 is divided into two hollow sphere half shells 8 and 9. The plane of division is indicated at the line A-A. By means of a thread 12, a setting member 10 can be screwed into the seating disk 11 of the clamping fitting 2 bearing against the glass pane, which member simultaneously has the glass bolt 13 passing through the bore of the glass pane. The setting member 10, at its contact area with, in the plane of the Figure, the upper hollow sphere half shell 8 is provided with tapered surfaces 14, which bear against corresponding tapered surfaces 15 of the hollow sphere half shell 8 for the sensitive adjusting and setting of the ball-and-socket joint 3.

### LIST OF REFERENCE NUMERALS

1 single-point fixing
2 clamping fitting
3 ball-and-socket joint
4 connecting component
5 hollow sphere bearing shell
6 ball head
7 longitudinal axis
8 hollow sphere half shell
9 hollow sphere half shell
10 setting member
11 seating disk
12 thread
13 glass bolt
14 tapered surfaces
15 tapered surfaces
16 plane of division
A-A line of division

1.-5. (canceled)

6. A single-point holder for fixing a glass pane relative to a sub-construction or support, comprising:
two clamping fittings for clamping the glass pane therebetween, one of the two clamping fittings comprising a hollow sphere bearing shell;
a setting member connectable to the one of the clamping fittings; and
a connecting component connectable to the sub-construction or support and having a longitudinal axis, the connecting component comprising a ball head which is received in the hollow sphere bearing shell,
wherein the hollow sphere bearing shell is divided into first and second semi-spherical bearing shells in a plane normal to the longitudinal axis of the connecting component, the first and second semi-spherical bearing shells and the ball head forming a ball-and-socket joint, and
wherein when connected to the one of the two clamping fittings, the setting member sets and fixes the first and second semi-spherical bearing shells relative to each other.

7. The holder of claim 6, wherein the other of the two clamping fittings being a complementary clamping fitting, the one of the two clamping fittings comprising a seating disk configured for bearing against the glass pane, the setting member being threaded into the seating disk and comprising a glass bolt for passing through a bore of the glass pane.

8. The holder of claim 6, wherein the first semi-spherical bearing shell has a tapered surface and the setting member has a corresponding tapered surface which engages the tapered surface of the first semi-spherical bearing shell when the setting member sets and fixes the first and second semi-spherical bearing shells relative to each other.

9. The holder of claim 6, wherein the ball head of the connecting component and the hollow sphere bearing shell comprise different materials.

10. The holder of claim 9, wherein the ball head of the connecting component comprises an alloy steel and the hollow sphere bearing shell comprises a bearing bronze.
